(19) United States
(12) Patent Application Publication
(10) Pub. No.: US 2021/0297526 A1
(43) Pub. Date: Sep. 23, 2021

(54) Cable Pair Stabilizer Unit and Method and System for Generating Sealing Current

(71) Applicant: Enginuity Communications Corp., St. Charles, IL (US)

(72) Inventors: Sean Iwasaki, Chicago, IL (US); Stephen M. Todd, Geneva, IL (US); Winston Gadsby, Herndon, VA (US); Winifred Evans, Leesburg, VA (US)

(21) Appl. No.: 17/227,708

(22) Filed: Apr. 12, 2021

Related U.S. Application Data
(63) Continuation-in-part of application No. 16/385,171, filed on Apr. 16, 2019, now Pat. No. 10,979,555.
Application No. 16/385,171 is a continuation of application No. 14/959,260, filed on Dec. 4, 2015, now Pat. No. 10,298,748.
(60) Provisional application No. 62/089,224, filed on Dec. 8, 2014.

(51) Int. Cl. H04M 1/74; H04M 11/06; H04M 3/18; H04M 19/00

(52) U.S. Cl. CPC H04M 1/745; H04M 19/001; H04M 3/18; H04M 11/062

(57) ABSTRACT

The present subject matter relates to one or more devices systems and/or methods for generating sealing current at a customer's premises or residence and injecting the sealing current into a DSL service provider's telephone cables to prevent the oxidation or corrosion of wire splices or connections on the telephone cables transporting DSL services. A cable pair stabilizer unit is connected at the customer's premises or residence, between the service provider's telephone cables and the customer's residential gateway/modem. The cable pair stabilizer unit comprises circuitry for generating the sealing current and for injecting the sealing current into the service provider's telephone cables transporting DSL services. The cable pair stabilizer unit may be combined with an AC/DC power supply adapter as a single, integrated device. The cable pair stabilizer unit may alternatively be combined with or inside of the Residential Gateway as a single, integrated device.

### TECHNICAL FIELD

The exemplary teachings herein pertain to methods and systems for generating sealing current to condition telephone cables, and in particular, to methods and systems which generate and send current into a Service Provider's telephone lines for DSL only or other dry or non-powered broadband service. Specifically, the present disclosure relates to methods and systems, comprising electrical circuitry including a current generator and a current injector, for providing current into the Service Provider's telephone cables to prevent the oxidation or corrosion of wire splices or connections on the telephone cables transporting DSL services, to provide more reliable DSL, service.

### BACKGROUND

For typical DSL service involving one or two wire pairs, the Service Provider would combine POTS (plain old telephone service) and DSL, for service deployment POTS would provide the voice service and the DSL would provide the data and video content. The POTS and DSL services are typically deployed from different telecommunication equipment and locations. POTS is typically deployed from a Central Office facility located up to 18 kft away from the customer. DSL is typically deployed from an outside plant (OSP) equipment cabinet located 1-3 kft from the customer. The POTS and DSL are combined at the customer's facility or the DSL OSP equipment cabinet. See FIG. 1, Prior Art. With transportation costs responsible for up to 10% of a product's price point, many organizations are looking to logistics for growth. Making strategic advances not just in how the organization goes to market, but in how the organization gets to market can enhance customer service, decrease order-to-cash cycle times, reduce payment lead times, minimize taxes, and ultimately increase working capital. In fact, time compression and information accuracy within the transportation function can significantly re-shape the balance sheet.

POTS inherently provides current to power the customer's phone and to determine if the customer was ready to make a telephone call or hang up. This current also provided the additional benefit of maintaining the wire continuity connections (i.e. preventing oxidation) at wire splices or IDC wire connections between the Service Providers facility and the Customer Premise's or residence. The current prevents corrosion from occurring at these wire splices or IDC wire connections, which can be numerous. If any of the wire splices or IDC wire connections oxidizes, the telephone wire loses its ability to reliably transport DSL services. To support their tactical and operational decisions, organizations traditionally use two distinct systems: one to address tactical-planning issues, and one to address operational-planning issues. However, the use of two distinct systems for tactical and operations decisions presents numerous inefficiencies, limitations and disadvantages, due to a lack of or limited interaction between the two systems. It is desirable that the two systems interact with each other, since tactical decisions are necessary for, and place constraints on, operational planning decisions. Furthermore, tactical decisions establish defined resource requirements for operational decisions.

Currently, the customers are abandoning their POTS for their cell phones. The POTS is either disconnected or not initially deployed, such as with a DSL only service deployment. In either situation, the POTS current is no longer provided. When DSL service trouble calls increased, the Service Providers identified the problem as oxidation or corrosion at telephone cable wire splices or IDC wire connections. The solution to correct and prevent oxidation or corrosion was to subject the wire splices or IDC wire connections to low DC current (i.e. sealing or wetting current). Attempts have been made to install sealing current equipment at the same location as the DSL equipment or to have the DST equipment incorporate sealing current functionality. Both attempts were unsuccessful due to space, costs, power consumed, and thermal capabilities, more specifically as follows:

Space: DSL equipment is installed in an outdoor cabinet (called VRAD, Video-Ready Access Device), wherein the VRAD cabinet does not have space to effectively support sealing current generators and injectors.

Cost: The additional cost to provide sealing current generators and injectors on all DSL service would be relatively high.

Power Consumed: The VRAD cabinet's power source may not have the ability to generate sealing current for all DSL services.

Thermal: The VRAD cabinet was designed to support the heat generated from the DST equipment and other accessories. The added heat from sealing current generators could not adequately be supported.

The following prior art references relate to and/or discuss one or more of the above described issues, and are each herein fully incorporated by reference:

U.S. Pat. No. 5,131,033 entitled Sealing Current Generator for a Telephone Circuit, issued to Reum on Jul. 14, 1992.

U.S. Pat. No. 7,027,587 B2 entitled System and Method for Deriving Sealing Current, issued to Menasco, Jr. on Apr. 11, 2006,

U.S. Pat. No. 7,773,744 B1 endued System and Method for Terminating Sealing Current, issued to Joffe on Aug. 10, 2010.

U.S. Pat. No. 7,787,614 B2 entitled Sealing Current Terminator for Inhibiting Oxidation and Methods Therefore, issued to Duran et al. on Aug. 31, 2010.

U.S. Pat. No. 7,515,691 B2 entitled Method for Testing DSL Capability of Telephone Lines, issued to Warner on Apr. 7, 2009.

U.S. Pat. No. 7,656,811 B2 entitled Digital Subscriber Line Access Multiplexer Wiring Validation, issued to Young on Feb. 2, 2010.

U.S. Pat. No. 9,462,101 B2 entitled Method and Apparatus to Electronically Tag a Circuit Pair, issued to Kreiner on Oct. 4, 2016.

### SUMMARY

A cable pair stabilizer unit generates and injects or sends sealing or wetting current into the Service Provider's telephone cables for DST (digital subscriber line) service from the customer's premise or residence. The cable pair stabilizer unit utilizes or taps the customer's DSL residential gateway (i.e. modem) power supply adapter to generate the sealing current. By doing so, the cable pair stabilizer unit maintains the telephone cable wire splice continuity from the Service Provider's facility to the Customer Premises or Residence. This prevents the oxidation or corrosion of wire splices or connections on the telephone cables transporting DSL services, which would otherwise cause errors or loss of service on the DSL service. As a result, the DSL service, which is transported or carried by the telephone cables, is more reliable.

Accordingly, the ability of the cable pair stabilizer unit to generate and send sealing current at the customers premises addresses the Service Provider's power and space limitation of sending the sealing current within their facilities, and overcomes the problems, disadvantages and limitations of there being high costs, limited space, limited power, and thermal challenges to generate sealing current from within the Service Provider's facility, namely the outside plant (OSP) equipment cabinet.

The cable pair stabilizer unit includes a test signature to further assist the Service Provider's operation, administration, maintenance, and provisioning (OAM&P) DSL services. The cable pair stabilizer's test signature will ensure that Service Provider will per form timely repairs on DSL services or prevent DSL service degradations. The cable pair stabilizer's test signature imprints notch or marker or the Service Provider's DSL service monitoring and testing processes to identify that the cable pair stabilizer unit is present and installed on the telephone cable providing DSL services. The Service Provider will use this information to determine if the DSL service exhibiting performance issues can be resolved by installing a cable pair stabilizer on the DSL service or initiate other repair solution. If the DSL service exhibits performance issues and the cable pair stabilizer unit is not detected, the Service Provider can immediately troubleshoot and repair the DSL service by installing a cable pair stabilizer 100 on the DSL cable pair 300. If the DSL service has service performance issues relating and a cable pair stabilizer 100 is detected, the Service Provider can address the DSL service problem by sending a technician to immediately repair the DSL service. In summary, the test signature will enable the Service Provide to quickly and efficiently resolve or prevent DSL service performance issues. The test signature will also reduce the Service Provider's costs by minimizing residential service calls or truck rolls.

Additional advantages and novel features will be set forth in part in the description which follows, and in part will become apparent to those skilled in the art upon examination of the following and the accompanying drawings or may be learned by production or operation of the examples.

### BRIEF DESCRIPTION OF THE DRAWINGS

The drawing figures depict one or more implementations in accord with the present teachings, by way of example only, not by way of limitation. In the drawing figures, like reference numerals refer to the same or similar elements.

FIG. 1 is a schematic diagram illustrating, traditional combined POTS and DSL service.

FIG. 2 is a schematic diagram of one embodiment of the method(s) and system(s) of present disclosure.

FIG. 3 is an enlarged schematic diagram of the cable pair stabilizer unit of FIG. 2, illustrating its internal components.

FIG. 4 is a perspective view of the cable pair stabilizer unit of FIG. 2.

FIG. 5 is an opposite perspective view, from that shown in FIG. 4, of the cable pair stabilizer unit of FIG. 2.

FIG. 6 is a perspective view illustrating a prior art residential gateway/modem configuration.

FIG. 7 is a perspective view illustrating the cable pan stabilizer unit of FIGS. 4 and 5 connected into the residential gateway/modem configuration of FIG. 6.

FIG. 8 is a first exemplary circuit diagram of the cable pair stabilizer unit of FIG. 2.

FIG. 9 is a second exemplary circuit diagram of the cable pair stabilizer unit of FIG. 2.

FIG. 10 is a third exemplary circuit diagram of the cable pair stabilizer unit of FIG. 2.

FIG. 11A is a schematic view of a typical prior art AC/DC power supply adapter.

FIG. 11B is a schematic view of an alternate embodiment of the present disclosure illustrating an integrated cable pair stabilizer unit and AC/DC power supply adapter, with an integrated RJ11/1RJ14 cable assembly.

FIG. 11C is a schematic view of an alternate embodiment of the present disclosure illustrating an integrated cable pair stabilizer unit and AC/DC power supply adapter, with an RJ11/RJ jack.

FIG. 11D is a detailed schematic view of the integrated cable pair stabilizer unit and AC/DC power supply adapter of FIG. 11C, illustrating an exemplary circuit diagram for the same.

FIG. 11E is a detailed schematic view of the integrated cable pair stabilizer unit and AC/DC power supply adapter of FIG. 11C, illustrating and alternate circuit diagram using a High Voltage Isolation circuitry of the AC/DC power supply adapter.

FIG. 11F is a perspective view illustrating the integrated cable pair stabilizer unit and AC/DC power supply adapter of FIG. 11B connected with a residential gateway/modem.

FIG. 12A is a schematic view of sealing current termination circuitry incorporated into a DSL Access Line Card.

FIG. 12B is a schematic view of sealing current termination circuitry incorporated into a DSL Splitter Line Card.

FIG. 13A is a schematic view of an alternate embodiment of the sealing current generator using a Positive Temperature Coefficient (PTC) device.

FIG. 13B is a schematic view of an alternate embodiment of the sealing current generator using a Potentiometer and a Controller device.

FIG. 13C is a schematic view of the alternate embodiment sealing current generator waveform of the PTC device of FIG. 13A.

FIG. 13D is a schematic view of the alternate embodiment sealing current generator waveform of the Potentiometer device of FIG. 13B.

FIG. 14 is a schematic view of an alternate embodiment of the present disclosure illustrating an integrated cable pair stabilizer unit and Residential Gateway.

FIG. 15 is a schematic diagram of one embodiment of the method(s) and system(s) of present disclosure with a test signature.

FIG. 16 is another schematic diagram of one embodiment of the method(s) and system(s) of present disclosure with a test signature.

FIG. 17 is an enlarged schematic diagram of the cable pair stabilizer unit of FIG. 15, illustrating its internal components with the test signature.

FIG. 18A is a first exemplary circuit diagram of the cable pair stabilizer unit.

FIG. 18B is an alternate embodiment of FIG. 18A.

FIG. 19A is a second exemplary circuit diagram of the cable pair stabilizer unit.

FIG. 19B is an alternate embodiment of FIG. 19A.

FIG. 20 is a graphical representation of a DSL Bit Loading used by the Service Provider to monitor and analysis DSL service with a cable pair stabilizer with a test signature.

### DETAILED DESCRIPTION

The following description refers to numerous specific details which are set forth by way of examples to provide a thorough understanding of the relevant method(s) and system(s) disclosed herein. It should be apparent to those skilled in the art that the present disclosure may be practiced without such details. In other instances, well known methods, procedures, components, hardware and/or circuitry have been described at a relatively high-level, without detail, in order to avoid unnecessarily obscuring aspects of the present disclosure. While the description refers by way of example to methods and systems for transport management, it should be understood that the method(s) and system(s) described herein may be used in any situation where logistics is needed or desired.

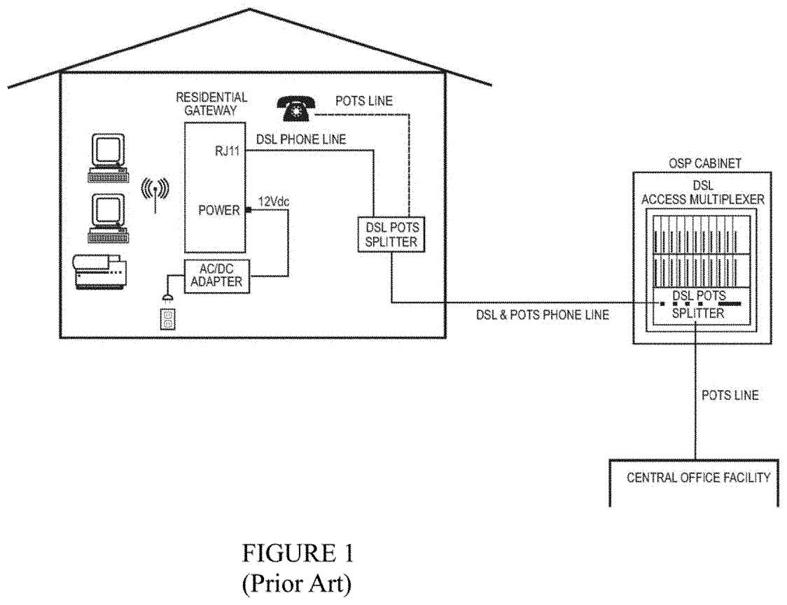

FIG. 1 is schematic diagram of combined POTS and DSL service delivered by a Central Office to a customer's facility through a DSL OSP equipment cabinet, as is known in the prior art. The current provided by POTS maintains the wire continuity connections by preventing oxidation at wire splices or IDC wire connections between the Service Providers facility (i.e. Central Office and OSP equipment cabinet) and the Customer Premises or residence.

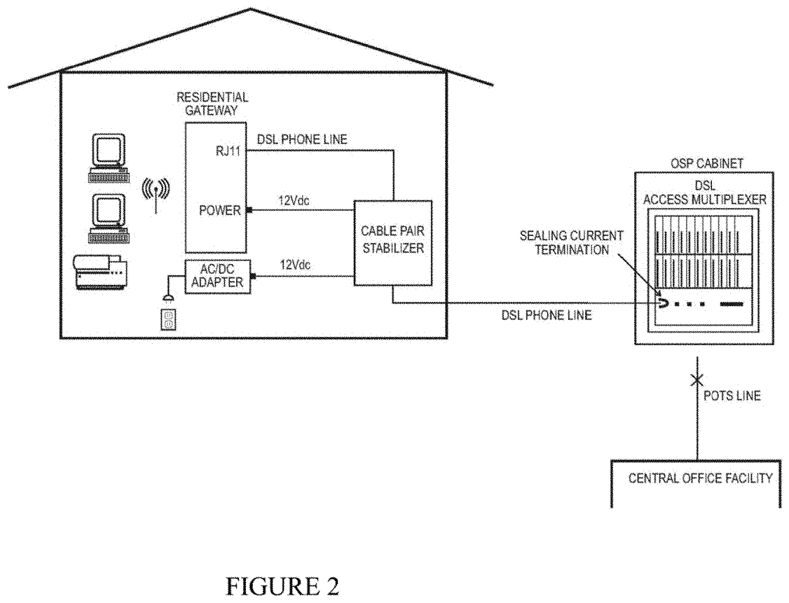

FIG. 2 is a schematic diagram of a preferred embodiment of the present disclosure, where the POTS is either disconnected, or was not initially deployed. Thus, a DSL only service deployment is illustrated. As such, no current is provided by the POTS to maintain the wire continuity connections and prevent oxidation at wire splices or IDC wire connections. To remedy this situation, a cable pair stabilizer unit is provided and connected, at the Customer's Premises or residence, to the DSL only service. The cable pair stabilizer unit generates and provides a sealing or wetting current from the customer premises into the Service Provider's telephone cables for DSL service.

As can be seen, there are four lines connected or running to or from the cable pair stabilizer unit. The following is a description of each of these four lines (in no order of importance. i.e., the designations first, second, third and fourth are randomly assigned solely for a point of reference or illustration purposes). The first line is an AC/DC power supply adapter, which is connected at one end to the cable pair stabilizer unit to provide power to the unit when it is plugged into an electrical outlet at its other end. The second line is a 12 Vdc power cord or line, which extends from the cable pair stabilizer unit and is connected to the customer's residential gateway or modem, to provide power to the residential gateway/modem from the AC/DC power supply, through the cable pair stabilizer unit. The third line is a DSL phone line, which is connected to the cable pair stabilizer unit at one end, and to the Service Provider's telephone cables for DSL service at the other end, typically by plugging the DSL phone line into a wall jack located at the customer's premises. Finally, the fourth line is a DSL phone line which extends from the cable pair stabilizer unit and is connected to the customer's residential gateway or modem, to provide DSL service to the residential gateway/modem from the wall jack leading to the Service Provider's telephone cables, and through the cable pair stabilizer unit.

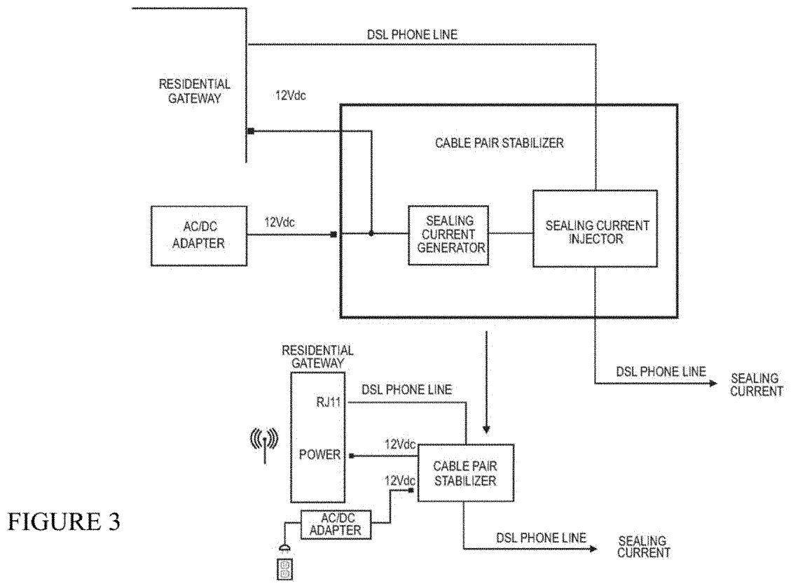

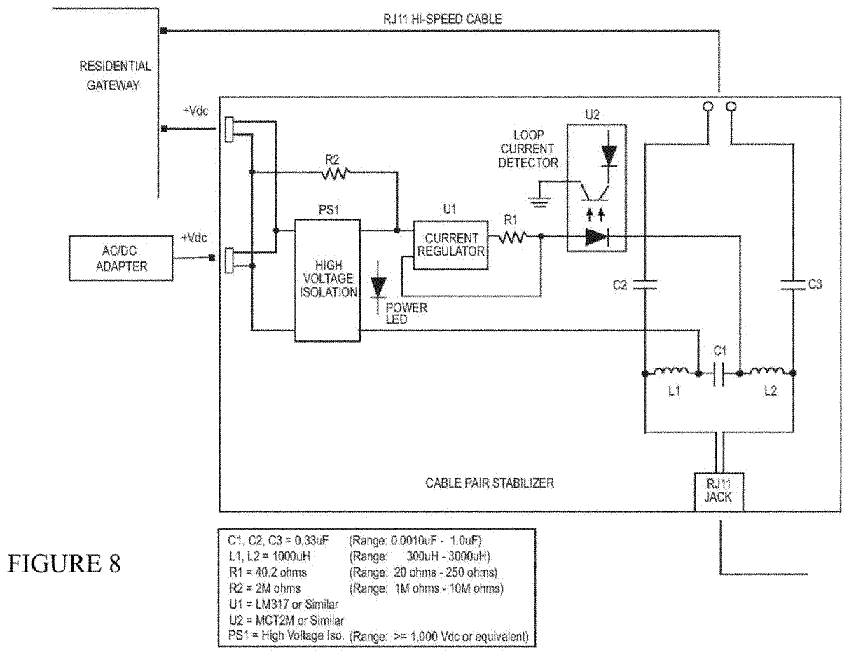

FIG. 3 is an enlarged view of cable pair stabilizer unit of FIG. 2 illustrating its internal components. As can be seen in FIG. 3, the cable pair stabilizer unit comprises a sealing current generator or regulator, for generating the sealing current, and a sealing current injector, for injecting the sealing current into the Service Providers telephone cables for DSL service. The sealing current generator/regulator and the sealing current injector both comprise electrical circuitry, as illustrated in the respective embodiments of FIGS. 8-10, which may be provided on a printed circuit board.

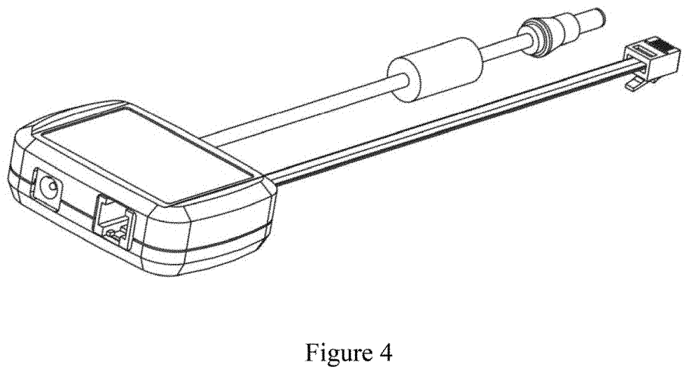

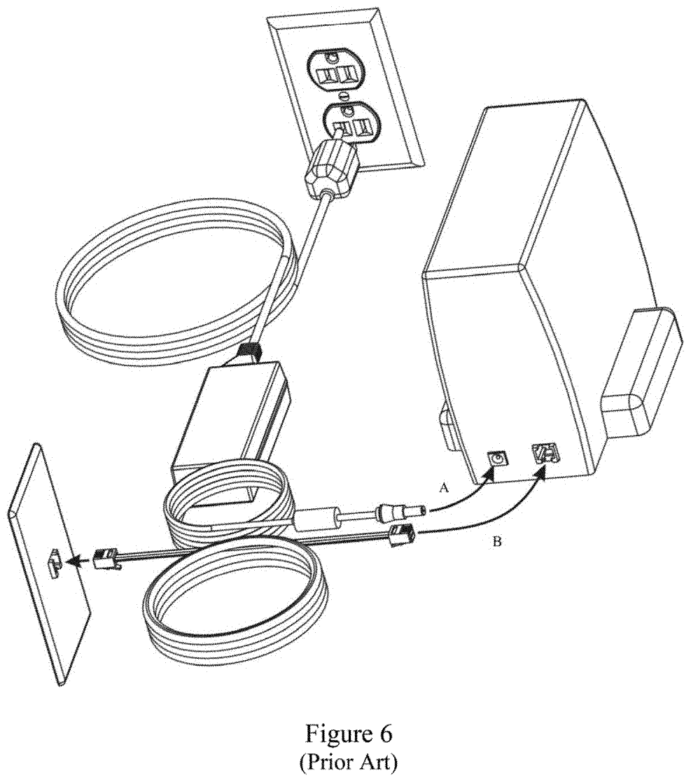

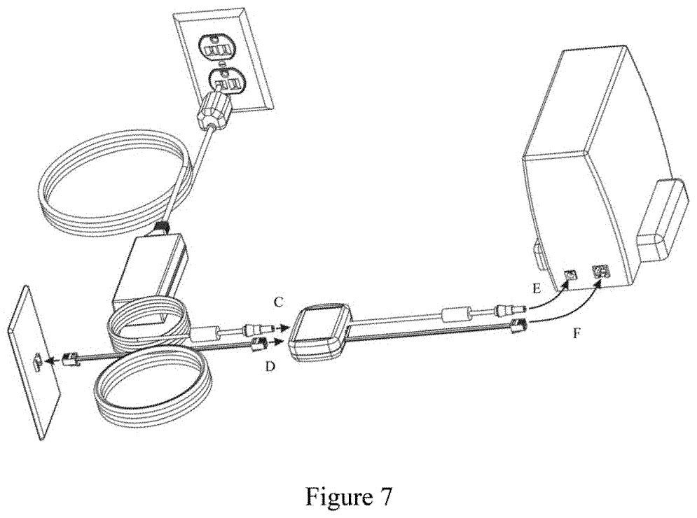

FIG. 4 is a perspective view of the cable pair stabilizer unit. As can be seen, the cable pair stabilizer unit comprises a housing, which houses the electrical circuitry for the sealing current generator and the sealing current injector. A 12 Vdc power jack is provided on the housing for connecting the AC/DC power supply adapter (first line), as discussed above with reference to FIG. 2 and illustrated in FIGS. 6 and 7. A DSL phone line jack is also provided on the housing for connecting a DSL phone lime (third line), as discussed above with reference to FIG. 2 and illustrated in FIGS. 6 and 7. Additionally, a 12 Vdc power cord or line (second line), extends from the housing for connection with the residential gateway/modem, as discussed above with reference to FIG. 2 and illustrated in FIG. 7. A DSL phone hue (fourth line), also extends from the housing for connection with the residential gateway/modem, as discussed above with reference to FIG. 2 and illustrated in FIG. 7. Accordingly, it should be understood that the circuitry inside the cable pair stabilizer unit housing allows both power from the AC/DC power supply adapter, and the DSL service from the DSL phone line, to flow through the cable pair stabilizer unit to the residential gateway/modem, while at the same time generating sealing current and sending the sealing current out through the wall jack and into to the Service Provider's telephone cables.

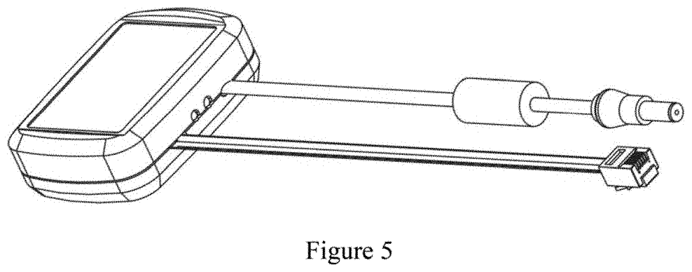

FIG. 5 is an opposite perspective view, from that shown in FIG. 4, of the cable pair stabilizer unit. Again, as illustrated, the housing of cable pair stabilizer unit has two lines extending therefrom, i.e., the 12 Vdc power cord or line (second line), and the DSL phone line) (fourth line). As can be seen, the power cord line has a female plug at its free end, which plugs into the residential gateway modem, as shown in FIG. 7. The DSL phone line has a male connector at its free end, which plugs into the residential gateway modem, as shown in FIG. 7. Also provided on the housing of the cable pair stabilizer unit are two indicator lights or LEDs. The light closest to the power cord line is the power indicator light (preferably green). This light will be illuminated when the cable pair stabilizer unit is connected to the power cord (first line) when plugged into a power outlet. The light closest to the DSL phone line is the sealing current indicator light (preferably yellow). This light will be illuminated when the cable pair stabilizer unit is generating and supplying the sealing current to the Service Provider's telephone cables through the DLS phone cord connected to the wall jack.

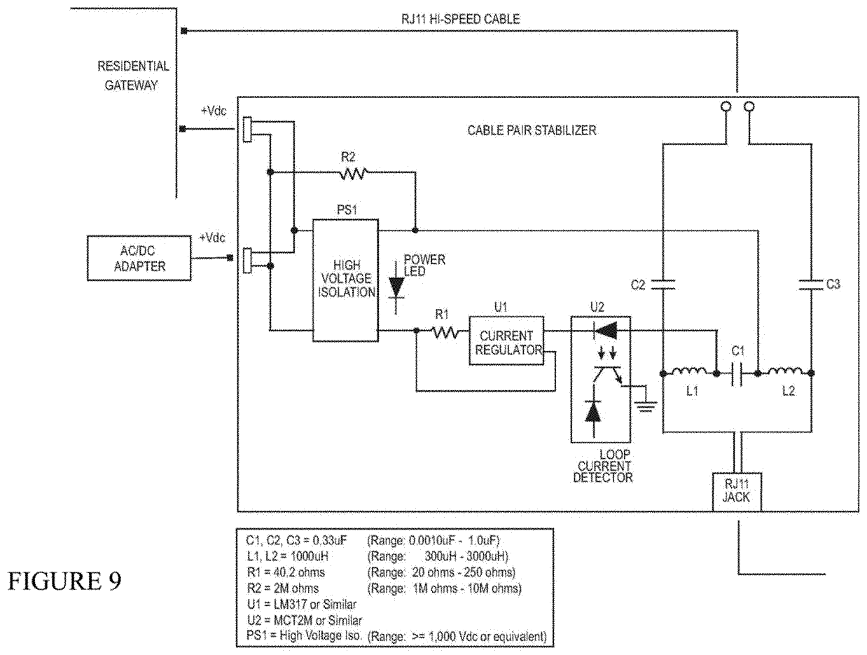

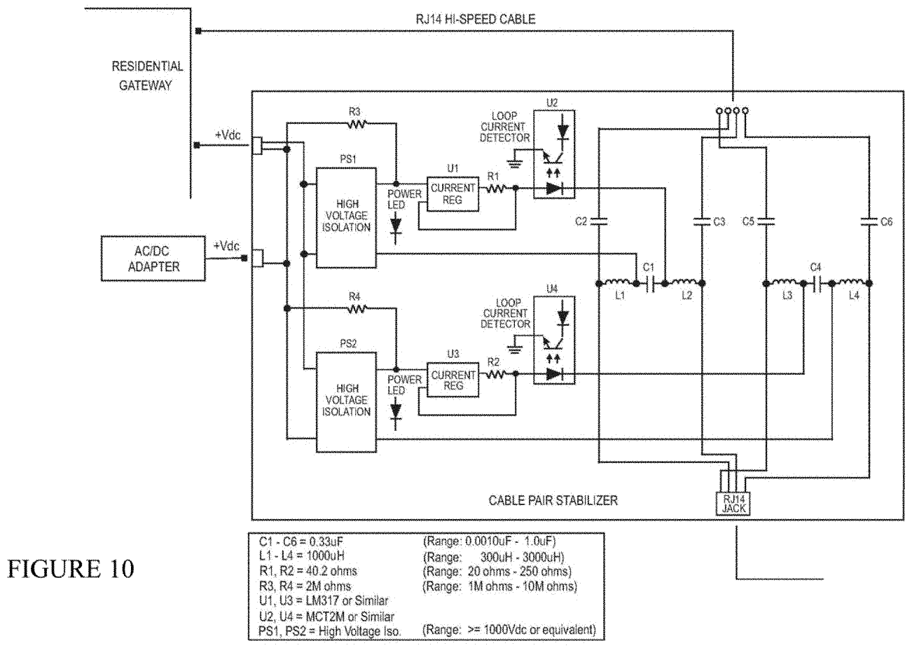

The embodiments illustrated in FIGS. 8 and 9, for DSL service involving one wire pair, will have this illustrated configuration of one power indicator LED and one sealing current indictor LED. The embodiment illustrated in FIG. 10, for DSL service involving two wire pairs, will have an additional sealing current and power indictor LEDs, i.e., four total LEDs, namely two power indictor LEDs and two sealing current indicator LEDs. This is because the cable pair stabilizer unit of the embodiment of FIG. 10 has two current generators, as discussed in more detail below.

Referring now to FIGS. 6 and 7, a residential gateway modem is illustrated. If in use without the cable pair stabilizer unit, as shown in the typical prior art configuration of FIG. 6, the modem's power cord (first line) is plugged into a power outlet, and the female plug at its other free end is connected directly to the residential gateway/modem, as illustrated by the arrow A in FIG. 6. Similarly, the DSL phone line (third line) is connected to a wall jack, and the male connector at its other free end is connected directly to the residential gateway/modem, as illustrated by the arrow B in FIG. 6.

To connect the cable pair stabilizer unit, as illustrated in FIG. 7, the power cord (first line), if connected to the residential gateway modem, is disconnected and then plugged into the cable pair stabilizer unit, as illustrated by the arrow C in FIG. 7. The DSL phone line (third line), if connected to the residential gateway/modem, is disconnected and then plugged into the cable pair stabilizer unit, as illustrated by the arrow D in FIG. 7. Next, the power cord or line (second line) extending from the housing of the cable pair stabilizer unit is connected to the residential gateway modem, as illustrated by the arrow E in FIG. 7. Similarly, the DSL phone line (fourth line) extending from the housing of the cable pair stabilizer unit is connected to the residential gateway/modem, as illustrated by the arrow F in FIG. 7.

FIG. 8 illustrates a circuit diagram of the cable pair stabilizer unit, as well as the four lines which are connected to the cable pair stabilizer unit. The DC jack for connection of the AC/DC power supply cord (first line) is illustrated at the left center of the circuit diagram. The power cord line (third line) which extends from the cable pair stabilizer unit housing to the residential gateway is illustrated at the upper left of the circuit diagram. The DSL phone line jack for connection of the DSL phone cord (second line) leading to the service provider's wire pair, is illustrated at the lower right of the circuit diagram. The DSL phone line (fourth line) which extends from the cable pair stabilizer unit housing to the residential gateway is illustrated at the upper right of the circuit diagram.

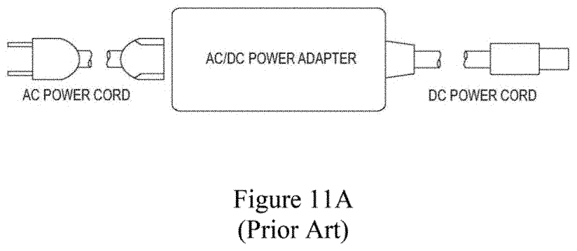

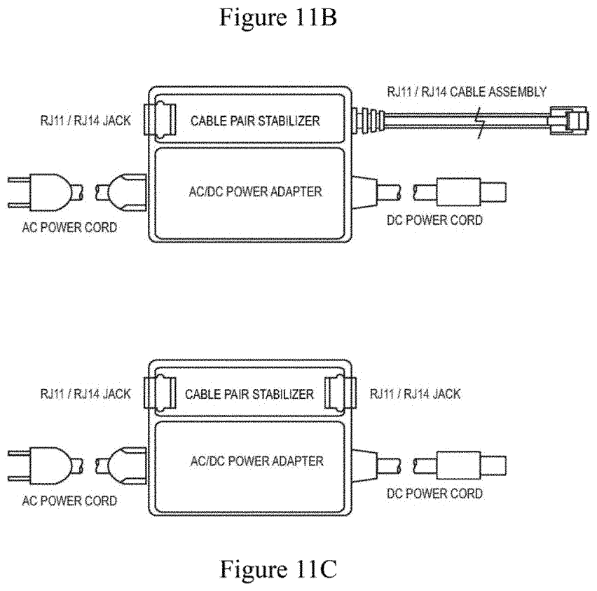

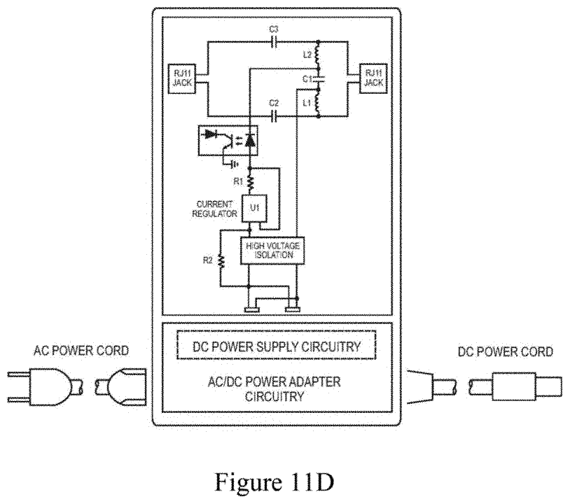

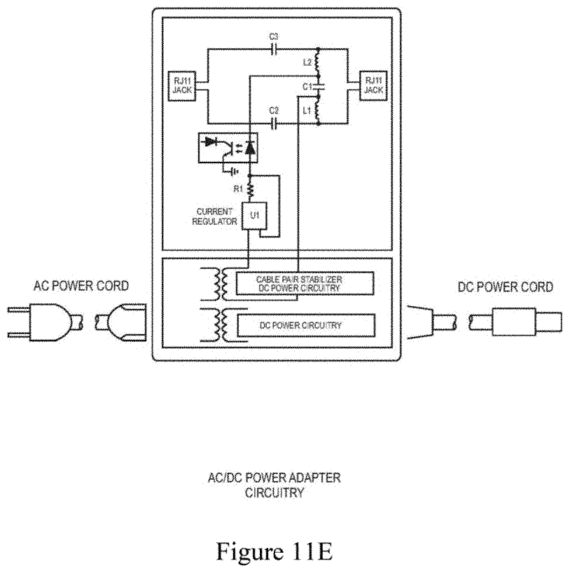

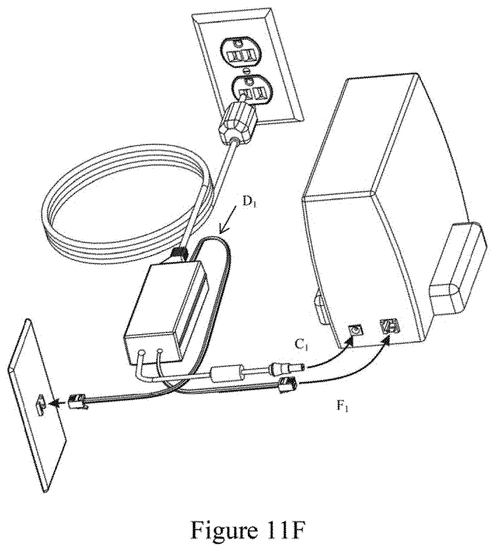

The High Voltage Isolation circuitry, PS1, is illustrated in FIG. 8 approximately in the left center of the circuit diagram. The High Voltage Isolation circuitry provides 1500V dielectric insulation between the 12 Vdc power jack and the DSL phone line jack. The 1500V dielectric insulation meets the requirement of Underwriter Laboratories UL60950. PS1 is preferably a PDS1-S12-S15-S. Another example of a High Voltage Insulation circuitry would be an additional winding(s) on the transformer in the AC/DC power supply adapter, as discussed below with respect to FIG. 11E.

The sealing current generator circuitry, U1, is illustrated in the left center of the circuit diagram. U1 is preferably an LM317 or similar. The loop current detector circuitry, U2, which includes the sealing current indicator LED, is illustrated to the right of the scaling current generator, U1, U2 is preferably an MCT2M or similar. The sealing current injector circuitry, C1-C3 and L1-L2, is illustrated on the right side of the circuit diagram. Ranges for values of this circuitry C1-C3 and L1-L2, along with preferred values, are set forth in the chart pictured below the circuit diagram in FIG. 8. Also illustrated in the circuit diagram are the power indicator LED, and two resistors, R1 and R2, the range values and a preferred value of which are also set forth in the chart pictured below the circuit diagram in FIG. 8.

FIG. 9 illustrates an alternate circuit layout of the components of the cable pair stabilizer unit from that shown in FIG. 8, and in particular with respect to the current regulator/generator and loop current detector. The circuit diagram of FIG. 9 is provided as an alternative embodiment to provide different voltage readability on the RJ11 wire pair. When the service personnel install or troubleshoot the cable pair stabilizer unit, the service personnel would use a digital multimeter to measure the voltage along the Service Provider's telephone cable pair or pairs. The circuit diagram of FIG. 8 would measure approximately −6 Vdc on each wire to ground and 12 Vdc across both wires. The circuit diagram of FIG. 9 would measure approximately −12 Vdc on a wire to ground and the other wire would measure approximately 0 Vdc on a wire to ground. The range values and a preferred value of the circuitry in FIG. 9 are the same as in FIG. 8, as set forth in the chart pictured below the circuit diagram in FIG. 9.

Accordingly, the scaling current generator/regulator taps the 12 Vdc (12 volts DC) power from the residential gateway AC/DC power supply to create the sealing current (greater than 5 mA milliamps DC). The sealing current injector injects or adds the sealing current into the telephone cable without disrupting the DSL service. The scaling current injector only allows the sealing current to flow into the telephone cable going out to Service Provider's network. The scaling current injector blocks the scaling current from entering into the residential gateway/modem by capacitors C2 and C3.

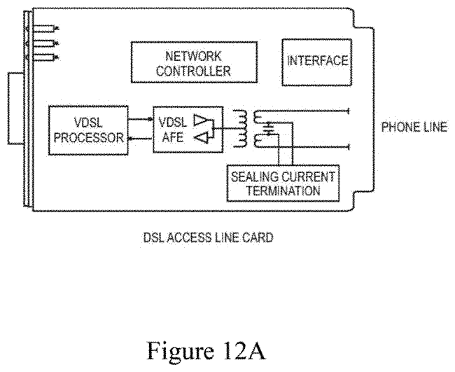

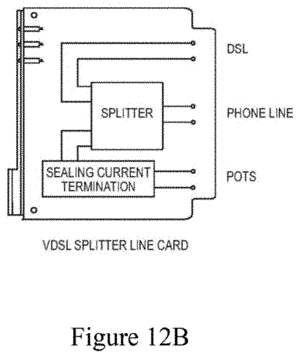

Since the POTS line is either disconnected or not installed, the DSL cable pair(s) require a “sealing current termination” (see FIG. 2) to close or complete the sealing current loop. This “sealing current termination” is typically performed by equipment located at the OSP cabinet or other locutions where the DSL cables pair(s) can be appropriately accessed to implement the sealing current termination. For example, the “sealing current termination” can be accomplished using a “wire short” on IDC connectors, by various DC current termination circuitry, such as an electronic inductor. Alternatively, the sealing current termination circuitry can be implemented on a DSL Access Line Card or DSL Splitter Line Card as illustrated in FIG. 12A and FIG. 12B, respectively. FIG. 10 is a circuit diagram of the cable pair stabilizer circuit for two pairs or a 4-wire DSL service. As can be seen, the circuit design for the 4-wire DSL service requires an additional sealing current generator, U3 (LM317), an additional loop current detector, U4 (MCT2M), and an additional sealing current injector, C4-C6 and L3-L4, to ensure noise and transient isolation between the two (2) telephone pairs. The cable stabilizer design for 4-wire applications uses the same general concepts of the sealing current generator/regulator and injector as described above with respect to the single pair DSL service. The generators and injectors will have the same functionality, but the design differs as shown due to the 4-wires. The sealing current injectors only allow the scaling current to flow into the telephone cables going out to Service Provider's network. The sealing current injectors block the sealing current from entering into the residential gateway modem by capacitors C2 and C3, and capacitors C5 and C6, respectively. The range values and a preferred value of the circuitry in FIG. 10 are set forth in the chart pictured below the circuit diagram in FIG. 10.

In FIGS. 8-10, the flow of current starts from the power supply, goes through the cable pair stabilizer unit, into the DSL service loop of the Service Provider's telephone cables, and then back through the cable pair stabilizer unit to complete the loop. Accordingly, current flows from the power supply and into the sealing current generator circuitry where the sealing current is generated. The sealing current then flows into the sealing current injector circuitry where it is sent to the Service Provider's telephone lines, and shorted, for example, at the DSL OSP equipment cabinet. The sealing current loops around the Service Provider's telephone lines and is returned to the cable pair stabilizer unit, where it flows back to the power supply jack to complete the circuit.

FIGS. 11B-11F illustrate an alternate embodiment of the present disclosure, wherein the cable pair stabilizer unit is integrated with an AC/DC power supply adapter. Accordingly, instead of having to use a separate cable pair stabilizer unit, as shown in FIGS. 4, 5 and 7, and a separate AC/DC power supply adapter, as shown in FIGS. 7 and 11A, a single, integrated device comprising a combined cable pair stabilizer unit and AC/DC power supply adapter in a single housing, as shown in FIGS. 11B-11F, is used. As can be seen in FIGS. 11B-11F, this integrated device has, in addition to a standard AC power cord connector and DC power cord, an RJ11/RJ14 jack for connecting a DSL phone line, and an RJ11/RJ14 cable assembly (FIG. 11B) or an RJ11/RJ14 jack (FIG. 11C) for connecting to the residential gateway/modem. It should be understood that all cable assemblies, whether for power or phone line, can be either integrated, or alternatively attached via a jack.

As illustrated in FIG. 11F, the integrated device is connected to the residential gateway/modem as follows. If a standard AC/DC power supply adapter is connected to the residential gateway/modem, it is unplugged and not used. The integrated device's DC power cord is instead plugged directly into the residential gateway/modem, as illustrated by the arrow C₁ in FIG. 11F. The DSL phone line, if connected to the residential gateway/modem, is disconnected and then plugged into the RJ11/RJ14 jack of the integrated device, as illustrated by the arrow D₁ in FIG. 11F. Similarly, the RJ11/RJ14 cable assembly extending from the housing of the integrated device is connected to the residential gateway modem, as illustrated by the arrow F₁ in FIG. 11F.

The integrated device functions in the same manner as the separate cable pair stabilizer unit and includes the cable pair stabilizer circuity as shown for example in one of the FIGS. 8-10. For example, the integrated device of FIG. 11D is shown incorporating the circuitry of FIG. 8. Alternatively, FIG. 11E illustrates an integrated cable pair stabilizer unit and AC/DC power supply adapter using an additional winding(s) to provide a high voltage isolation and voltage for the sealing current generator. In either embodiment, current flows from the power supply and into the scaling current generator circuitry within the integrated device, and the sealing current is generated. The sealing current then flows into the sealing current injector circuitry within the integrated device, where it is sent to the Service Provider's telephone lines, and shorted, for example, at the DSL OSP equipment cabinet. The scaling current loops around the Service Provider's telephone lines and is returned to the integrated device, where it flows back to the power supply jack to complete the circuit.

The integrated dev ice can have circuity for one wire pair or two wire pairs in the manner discussed above. For DSL service involving one wire pair, the integrated device will have the configuration of one power indicator LED and one sealing current indictor LED for a single current regulator or generator. For DSL service involving two wire pairs, the integrated device w ill have an additional sealing current indictor LED, i.e., three total LEDs, namely one power indictor LED and two sealing current indicator LEDs, one for each of the two current regulators or generators.

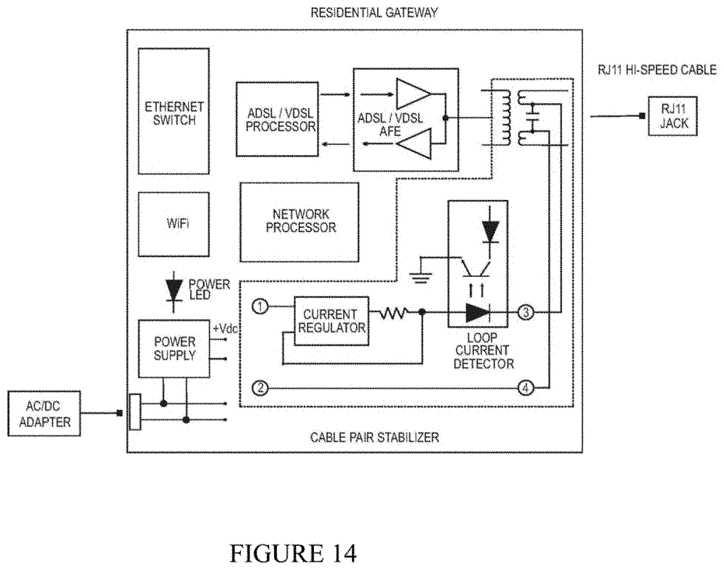

FIG. 14 illustrates an alternate embodiment of the present disclosure, wherein the cable pair stabilizer unit is integrated within a Residential Gateway. Accordingly, instead of having to use a separate cable pair stabilizer unit, as shown in FIGS. 4, 5 and 7, or an integrated cable pair stabilizer unit and AC/DC power adapter, as shown in FIGS. 11B-11F, a single, integrated device comprising a combined cable pair stabilizer unit and Residential Gateway is shown in FIG. 14. As can be seen in the circuit diagram of FIG. 14, the cable pair stabilizer circuitry, shown within the dotted outline, is integrated with the components of the Residential Gateway, inside of the Residential Gateway. The integrated cubic pair stabilizer circuitry and Residential Gateway will resemble front the exterior a traditional Residential Gateway and will connect in the same manner as a traditional Residential Gateway, as illustrated in FIG. 6. However, because the integrated Residential Gateway incorporates the cable pair stabilizer circuitry within the housing of the Residential Gateway, the desired sealing current is generated and provided from the customer premises into the Service Provider's telephone cables for DSL service, functioning in the same manner as the separate cable pair stabilizer unit.

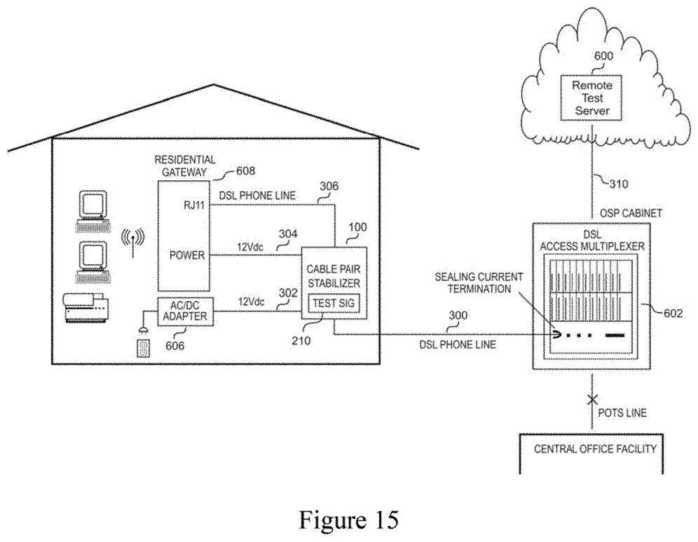

FIG. 15 is a schematic diagram of a preferred embodiment of a cable pair stabilizer 100 with a test signature 210. As shown in FIG. 15, there are four lines 300, 302, 304, and 306 connected or running to or from the cable pair stabilizer unit 100. The following is a description of each of these four lines (in no order of importance, i.e., the designations first, second, third and fourth are randomly assigned solely for a point of reference or illustration purposes). The first line 302 is an AC/DC power supply adapter 606 line, which is connected at one end to the cable pair stabilizer unit 100 to provide power to the unit when it is plugged into an electrical outlet at its other end. The second line 304 is a 12 Vdc power cord or line 304, which extends from the cable pair stabilizer unit 100 and is connected to the customer's residential gateway or modem 608, to provide power to the residential gateway modem 608 front the AC/DC power supply 606, through the cable pair stabilizer unit 100. The third line 300 is a DSL phone line, typically a twisted pair of wire, which is connected to the cable pair stabilizer unit 100 at one end, and to the Service Provider's telephone cables for DSL service at the other end, typically by plugging the DSL phone line 300 into a wall jack located at the customer's premises. The fourth line 306 is a DSL phone line 306 which extends from the cable pair stabilizer unit 100 housing to the residential gateway 608.

The DSL phone line 300 is connected to the Service Provider's DSL Access Multiplexer 602 for DSL service, monitoring, and testing. The DSL Access Multiplexer 602 is further connected to a Remote Test Server 600 through line 310. The DSL Access Multiplexer 602 provides the Remote Test Server 600 with DSL, service status and performance information on DSL services carried over the DSL phone line 300. The Remote Test Server 600 queries the DSL Access Multiplexer 602 to retrieve performance and status information on the DSL services. This DSL service performance and status information request is non-intrusive to the DSL service. The cable pair stabilizer 100 test signature 210 provides a marker for the Remote Test Server 600 and the DSL Access Multiplexer 602 to identify if a cable pair stabilizer 100 is installed on a DSL service line.

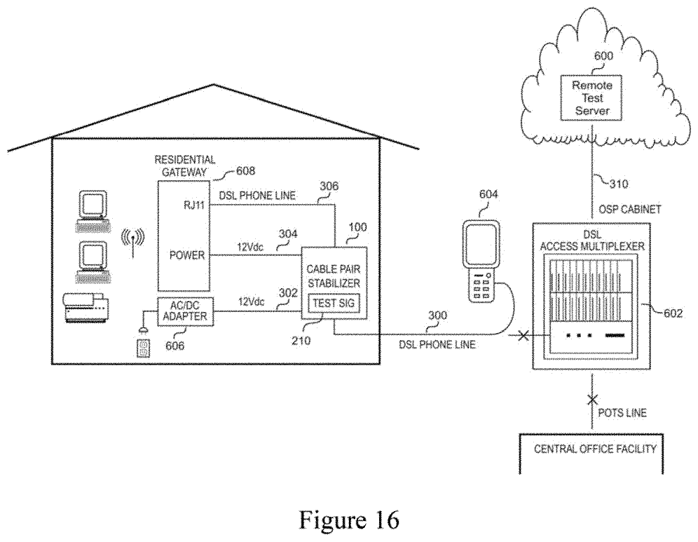

In FIG. 16, the cable pair stabilizer 100 test signature 210 can alternatively connect via line 300 to a portable DSL handheld test device 604 which can provide a bit loading graph or similar analysis such as the Viavi HST-3000 or Greenlee Sidekick, an identification marker that a cable pair stabilizer 100 is present and installed on a DSL service line. The cable pair stabilizer 100 test signature 210 in its present embodiment may also provide a marker for other test devices or equipment with or without the Residential Gateway 608 connected using other test devices and equipment. These other test devices or equipment can initiate a direct current (DC) or metallic testing to detect the test signature 210 marker or another embodiment of the test signature 210 marker. This test signature 210 marker or another embodiment of the test signature 210 marker will be a unique impedance measurement or provide a unique impedance impulse characteristics. A Mechanized Loop Tester (MLT) is an example of this other test device or equipment.

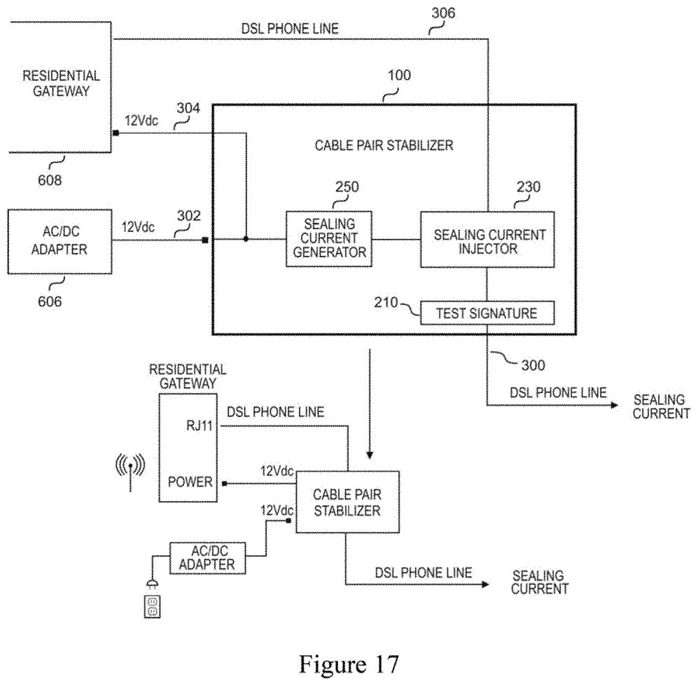

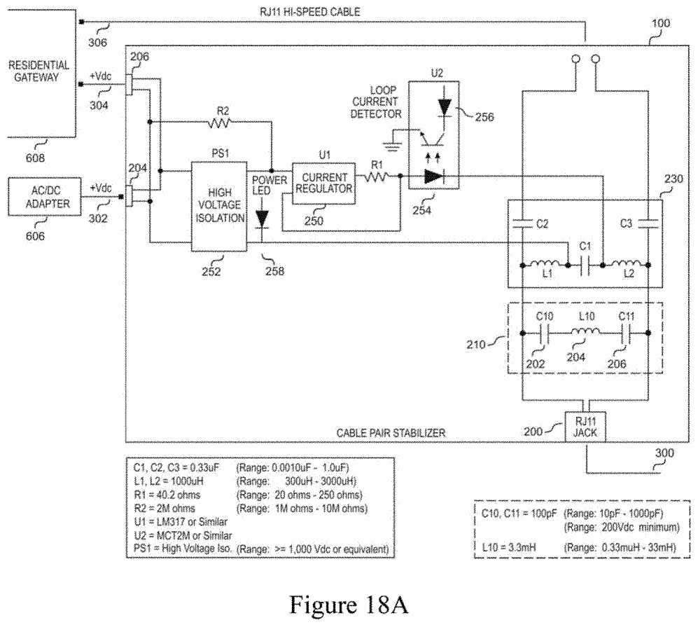

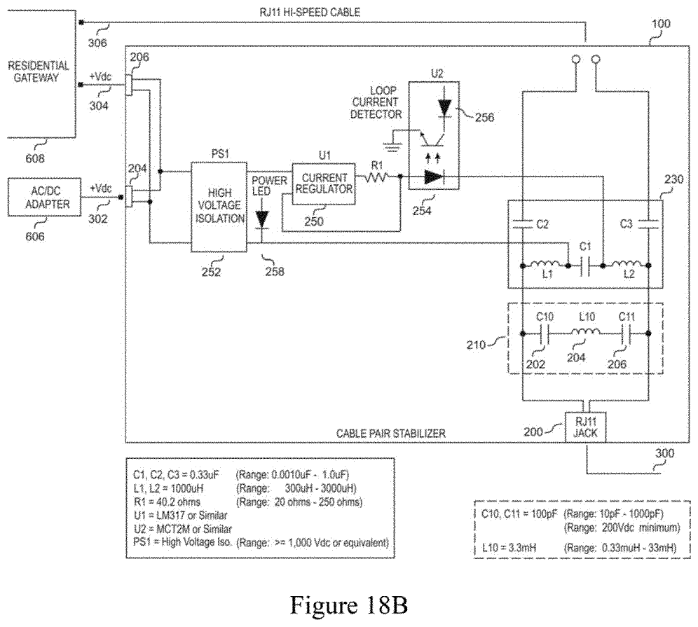

FIG. 17 is an enlarged view of cable pair stabilizer unit 100 of FIG. 15 illustrating its internal components. As can be seen in FIG. 15, the cable pair stabilizer unit 100 comprises a sealing current generator or regulator 250, for generating the sealing current, and a sealing current injector 230, for injecting the sealing current around the test signature circuit 210 and into the Service Provider's telephone cable pair 300 carrying DSL services. The sealing current generator/regulator 250, the sealing current injector 230, and the test signature 210 comprise of electrical circuitry, as illustrated in the respective embodiments of FIGS. 18A-B and 19A-B, which may be provided on a printed circuit board.

FIG. 18A illustrates a circuit diagram of the cable pair stabilizer unit 100 with the four lines connected. The cable pair stabilizer unit 100 housing has a DC jack 204 for connection of the AC/DC power supply cord (first line) 302 of the AC/DC Adapter 606 as illustrated at the loll center of the circuit diagram. The power cord line (third line) 304 extends from a DC output jack 206 of the cable pair stabilizer unit 100 housing to the residential gateway 608 as illustrated at the upper left of the circuit diagram. The cable pair stabilizer unit 100 housing also has a DSL phone line RJ11 jack 200 for connection of the DSL phone cord (second line) 300 leading to the service provider's wire pair, as illustrated at the lower right of the circuit diagram. The DSL phone line (fourth line) 306 extends from the cable pair stabilizer unit 100 housing to the residential gateway 608 as illustrated at the upper right of the circuit diagram.

The High Voltage Isolation circuitry PS1 252 is illustrated in FIG. 18A approximately in the left center of the circuit diagram. The High Voltage Isolation circuitry PS1 252 provides 1500V dielectric insulation between the 12 Vdc power jack 204 and the DC output jack 206 to the DSL phone line jack 200. The 1500V dielectric insulation meets the requirement of Underwriter Laboratories UL60950. PS1 252 is preferably a PDS1-S12-S15-S. Another example of a High Voltage Insulation circuitry would be an additional winding(s) on the transformer in the AC/DC power supply adapter, as discussed with respect to FIG. 11E, which illustrates an integrated AC/DC power supply adapter using an additional winding(s) to provide a high voltage isolation and voltage for the scaling current generator. The sealing current generator circuitry U1 250 is illustrated in the left center of the circuit diagram. U1 250 is preferably an LM317 or similar. The loop current detector circuitry U2 254, which includes the sealing current indicator LED 256, is illustrated to the right of the sealing current generator U1 250. U2 254 is preferably an MCT2M or similar optocoupler device. The scaling current injector circuitry 230, comprising capacitors C1-C3 and inductors L1-L2, is illustrated on the right side of the circuit diagram. Ranges for values of these capacitors C1-C3 and inductors L1-L2, along with preferred values, are set forth in the in the chart outlined with a solid line, pictured below the circuit diagram in FIG. 18A. The test signature 210 is comprised of capacitors C10 202, C11 206, and inductor L10 204, as illustrated on the right side of the circuit diagram. Ranges for values of capacitors C10 202, C11 206, and of inductor L10 204, along with preferred values, are set forth within the chart outlined with a dashed line, pictured below the circuit diagram in FIG. 18A.

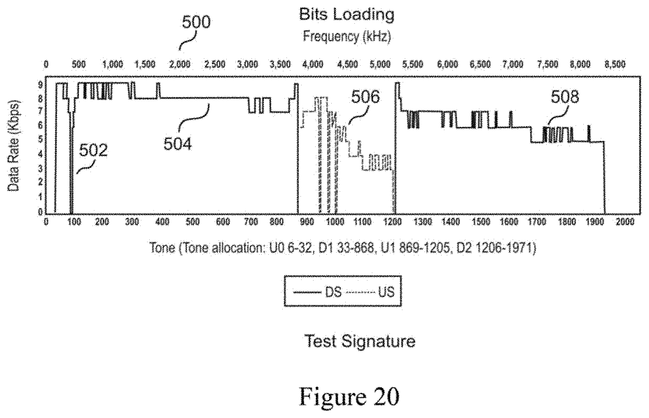

The test signature 210 produces a frequency notch or marker at 370 kHz. The test signature 210 frequency of 370 kHz avoids interference with plain old telephone services (POTS) and from the AM broadcast band (535 kHz to 1,750 kHz). In addition, the 370 kHz test frequency resides within the downstream lower frequency data bin groups to minimize noise to the adjacent data bins. Higher frequency downstream and upstream data bin groups are subjected to lower SNR issues due to DSL signal attenuation at high frequencies relative to noise. The test signature 210 has a center frequency of 370 kHz with a tolerance of +/−10% and an impedance of 100 ohms differential. The test signature 210 components capacitor 202 C10, capacitor 206 C11, and inductor 204 L10 were determined using a standard L-C circuit resonant frequency formula f=1/(2π√LC). The test signature 210 component values for capacitor C10 202, capacitor C11 206, and inductor L10 204 were then further adjusted during field testing. The test signature 210 can be comprised of one capacitor and one inductor, two inductors and two capacitors, and other similar component combinations, types, and values. Two capacitors are used in series, to obtain a higher total breakdown voltage than would be possible with a single capacitor. The capacitor(s) need a cumulative voltage rating to withstand any transients the circuit will see in operation. The inductor needs to have a fairly high quality value (Q) to ensure that the notch 562 (FIG. 20) has a steep, sharp, and narrow shape to minimize any possible data loss to the adjacent data bins. Capacitor C10 202, capacitor C11 206, and inductor L10 204 are required to have operational parameters in the frequency range of the system, roughly 25 kHz to 20 MHz. The test signature 210 frequency is also dependent upon the Service Provider's DSL service type, equipment, and service environment. The test signature 210 can have a test signature frequency anywhere within the 150 kHz to 500 kHz range. Also illustrated in the circuit diagram are the power indicator LED 258, and two resistors, R1 and R2, the range values and a preferred value of which are also set forth in the chart outlined with a solid line, pictured below the circuit diagram in FIG. 18A. In an alternate embodiment illustrated in FIG. 18B, the resistor R2 has been removed as a matter of design choice.

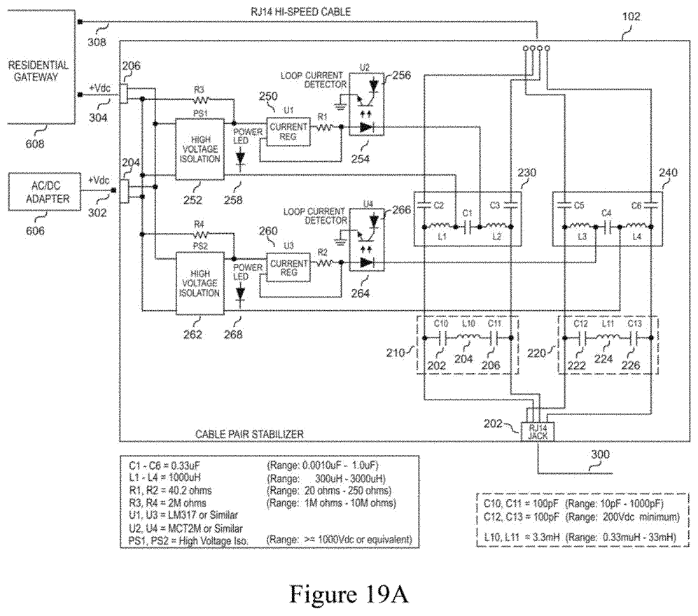

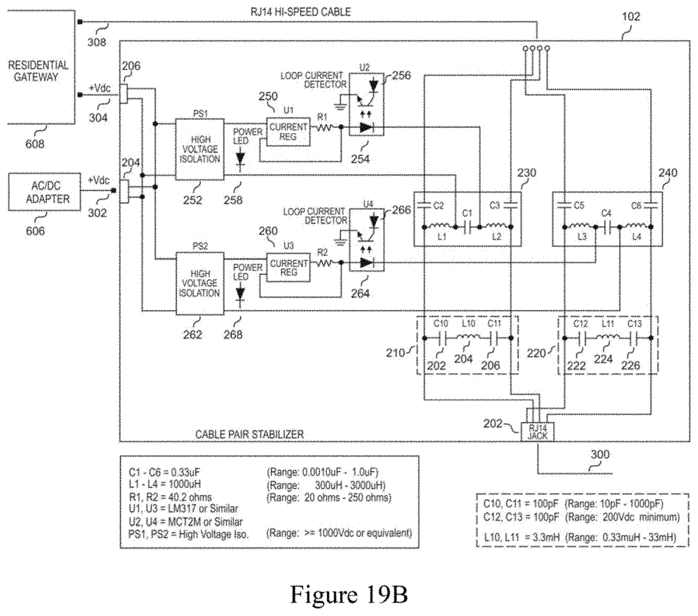

FIG. 19A illustrates a circuit diagram of another embodiment of the cable pair stabilizer unit 102 for two pairs or a 4-wire DSL service. The DC jack 204 for connection of the AC/DC power supply cord (first line) 302 of the AC/DC Adapter 606 is illustrated at the left center of the circuit diagram. The power cord line (third line) 304 which extends from the DC output jack 206 of the cable pair stabilizer unit 102 housing to the residential gateway 608 is illustrated at the upper left of the circuit diagram. The DSL phone line RJ14 jack 202 for connection of the DSL phone cord (second line) 300 leading to live service provider's wire pair, is illustrated at the lower right of the circuit diagram. The DSL phone line (fourth line) 308 which extends from the cable pair stabilizer unit 102 housing to the residential gateway 608 is illustrated at the upper right of the circuit diagram.

The High Voltage Isolation circuitry PS1 252 and PS2 262 are illustrated in FIG. 19A approximately in the left center of the circuit diagram. The High Voltage Isolation circuitry PS1 252 and PS2 262 provides 1500V dielectric insulation between the 12 Vdc power jack 204 and the DC output jack 206 to the DSL phone line jack 202. The 1500V dielectric insulation meets the requirement of Underwriter Laboratories UL60950. PS1 252 and PS2 262 are preferably a PDS1-S12-S15-S. Another example of a High Voltage Insulation circuitry would be an additional winding(s) on the transformer in the AC/DC power supply adapter, as discussed with respect to FIG. 11E, which illustrates an integrated AC/DC power supply adapter using an additional winding(s) to provide a high voltage isolation and voltage for the sealing current generator. The sealing current generator circuitry U1 250 and U3 260 are illustrated in the left center of the circuit diagram. U1 250 and U3 260 are preferably an LM317 or similar. The loop current detector circuitry U2 254, which includes the sealing current indicator LED 256, is illustrated to the right of the scaling current generator U1 250. The loop current detector circuitry U4 264, which includes the sealing current indicator LED 266, is illustrated to the right of the scaling current generator U3 260. U2 254 and U4 264 are preferably an MCT2M or similar optocoupler device. The sealing current injector circuitry 230, comprising capacitors C1-C3 and inductors L1-L2, is illustrated on the center right side of the circuit diagram. The scaling current injector circuitry 240, comprising capacitors C4-C6 and inductors L3-L4, is illustrated on the fur right side of the circuit diagram. Ranges for values of these capacitors C1-C6 and inductors L1-L4, along with preferred values, are set forth in the in the chart outlined with a solid line, pictured below the circuit diagram in FIG. 19A. The test signature 210 is comprised of capacitors C10 202, C11 206, and inductor L10 204, as illustrated on the center right side of the circuit diagram. The test signature 220 is comprised of capacitors C12 222, C13 226, and inductor L11 224, as illustrated on the far right side of the circuit diagram. Ranges for values of capacitors C10-C13 and inductors L10-L11, along with preferred values, are set forth within the chart outlined with a dashed line, pictured below the circuit diagram in FIG. 19A.

The test signature 210 and 220 produce a frequency notch or marker at 370 kHz. The test signature 210 and 220 frequencies of 370 kHz avoid interference with plain old telephone services (POTS) and from the AM broadcast band (535 kHz to 1,750 kHz). In addition, the 370 kHz test frequency resides within the downstream lower frequency data bin groups to minimize noise to the adjacent data bins. Higher frequency downstream and upstream data bin groups are subjected to lower SNR issues due to DSL signal attenuation at high frequencies relative to noise. The test signature 210 and the test signature 220 have a center frequency of 370 kHz with a tolerance of +/−10% and an impedance of 100 ohms differential. The test signature 210 components capacitor C10 212, capacitor C11 216, and inductor L10 214 and the test signature 220 components capacitor C12 222, capacitor C13 226, and inductor L11 224 were both determined using a standard L-C circuit resonant frequency formula f=1/(2π√LC). The test signature 210 and 220 component values for capacitor C10-C13 and inductors L10-L11 were then further adjusted during field testing. The test signatures 210 and 220 can be comprised of one capacitor and one inductor, two inductors and two capacitors, and other similar component combinations, types, and values. Two capacitors are used in series, to obtain a higher total breakdown voltage than would be possible with a single capacitor. The capacitor(s) need a cumulative voltage rating to withstand any transients the circuit will see in operation. The inductor needs to have a fairly high quality value (Q) to ensure that the notch 502 (FIG. 20) has a steep, sharp, and narrow shape to minimize any possible data loss to the adjacent data bins. Capacitor C10 202, capacitor C11 206, and inductor L10 204 are required to have operational parameters in the frequency range of the system, roughly 25 kHz to 20 MHz. The test signature 210 and 220 frequencies are also dependent upon live Service Provider's DSL service type, equipment, and service environment. The test signature 210 and 220 can have a test signature frequency anywhere within the 150 Hz to 500 kHz range. Also illustrated in the circuit diagram are the power indicators LED 258 and 268, and four resistors, R1-R4, the range values and a preferred value of which are also set forth in the chart outlined with a solid line, pictured below the circuit diagram in FIG. 19A. In an alternate embodiment illustrated in FIG. 19B, the resistors R3 and R4 have been removed as a matter of design choice.

FIG. 20 illustrates a Bit Loading graph 500 which is a graphical representation of the Service Providers DSL service monitoring and status analysis or frequency sweep performed by the DSL Access Multiplexer 602 (FIG. 15) or a portable DSL handheld test devices 604 (FIG. 16). The Bit leading graph 500 graphically illustrates the amount of data bits that are be carried per channel relative to the signal-to-noise ratio (SNR) at that particular frequency. A high SNR will result in more bits that can be allocated to that particular carrier bin. A carrier bin (sub-channel) is a specific frequency range where data bits are carried or transported. Each carrier bin within a specific frequency range will be responsible for either upstream or downstream data for the DSL service. The Bit Loading graph 500 shows the DSL service performance based upon bit rates and per frequency and carrier bins. The Bit Loading graph 500 further illustrates DSL service based upon upstream and downstream bin groups which reflects the nature of the DSL service. The DSL upstream bin data are represented by 506 and the DSL downstream bin data bin are represented by 504 and 508. When the DSL Access Multiplexer 602 initiates a frequency sweep on a DSL service with a Cable Pair Stabilizer 100 installed, the Cable Pair Stabilizer 100 test signature 210 creates a notch 502 in the bin data at a frequency of 370 kHz. The Service Provider can determine if a Cable Pair Stabilizer 100 is installed on a DSL, service by inspecting the Bit Loading graph 500 and identifying the notch 502. In the above described manner, the cable pair stabilizer unit and/or the integrated devices each have the ability to tap and generate sealing current using the residential gateway or modem power source. The sealing current is generated al the Customer's Premises and provides the required prevention of oxidation or corrosion at telephone cable wire splices or IDC wire connections from the Customer's Premises at a relatively low cost, thereby overcoming the disadvantages and limitations, including high costs, limited space, limited power, and thermal challenges associated with generating sealing current from within the Service Provider's facility or outside plant (OSP) equipment cabinet.

In an exemplary embodiment, the cable pair stabilizer unit shown in FIGS. 4, 5 and 7, is approximately 2.74 inches in length, 1.97 inches in width, and 0.83 inches in height. The housing of the unit is comprised of ABS plastic, 94 V0 Rated. The output voltage/current is −12 Vdc @ 30 mA±5 mA, or −15 Vdc @ 30 mA±5 mA. The input voltage/current is −12 Vdc @ 40 mA±5 mA (DC-DC Converter Efficiency), or −15 Vdc @ 40 mA±5 mA (DC-DC Converter Efficiency). Signal interoperability is ADSL, ADSL+, VDSL, VDSL2 compatible. Insertion loss is <0.2 dB (100 kHz-30 MHz). Wire connectors are 24 Gauge Twisted Pair Wire—12 inches. Regulatory compliance includes UL6095G and FCC Part 15 Class B. Operating temperature is −10° C. to 150° C.

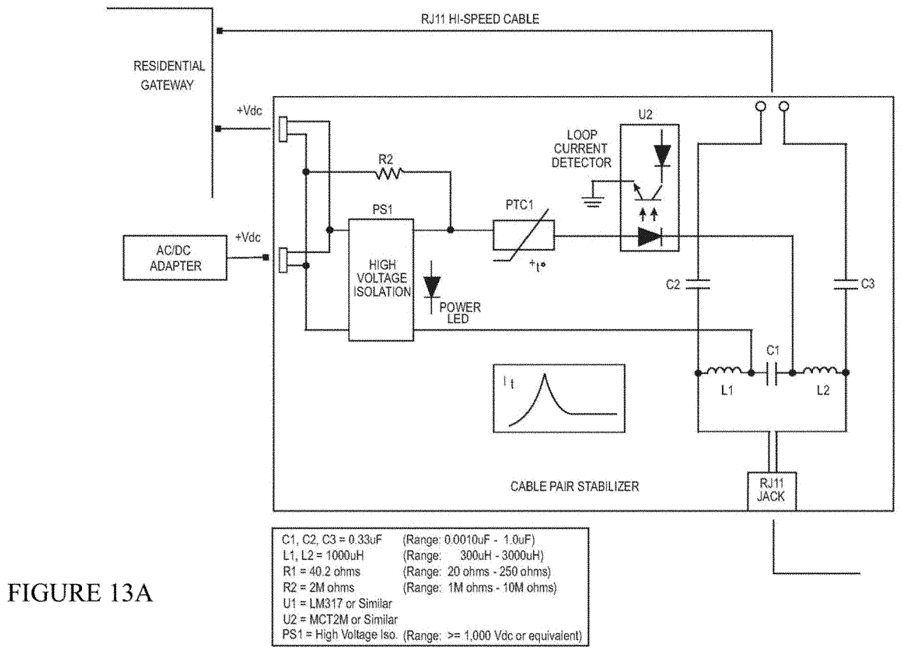

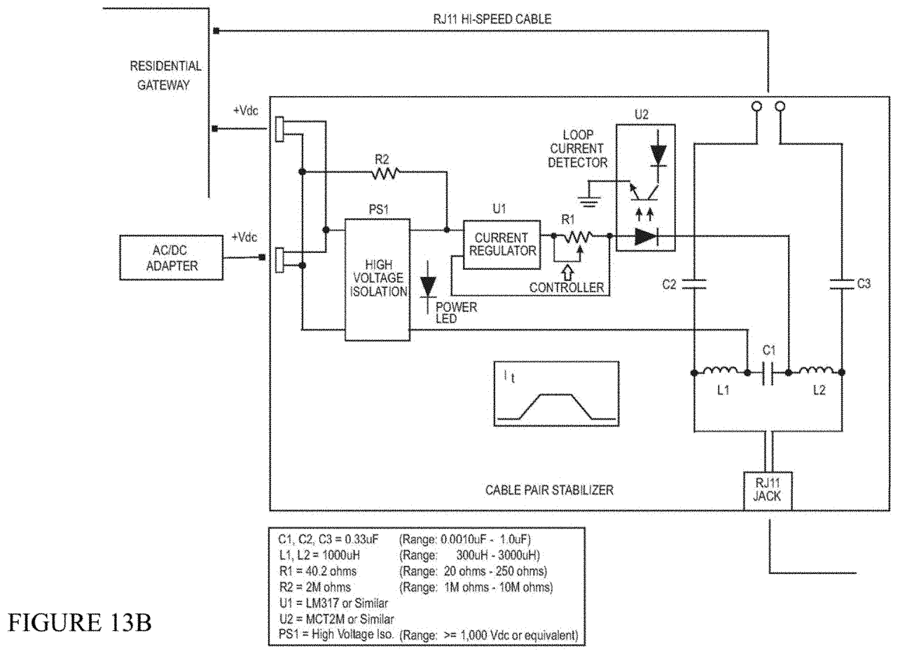

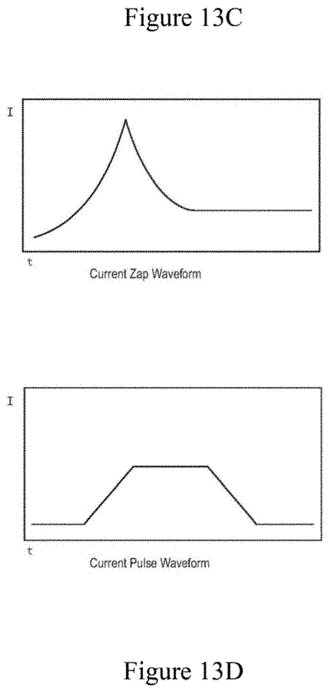

While the embodiment(s) disclosed herein are illustrative of the structure, function and operation of the exemplary method(s), system(s) and device(s), it should be understood that various modifications may be made thereto with departing from the teachings herein. Further, the components of the method(s), system(s) and device(s) disclosed herein can take any suitable form, including any suitable hardware, circuitry or other components capable of adequately performing their respective intended functions, as may be known in the art. For example, the sealing current generator can be implemented with a Positive Temperature Coefficient (PTC) device to provide a surge current (“current zap”) as illustrated in FIG. 13A. The sealing current generator can be implement using potentiometer type component and a controller, e.g., with a Potentiometer and Controller to produce a “current pulse” as illustrated in FIG. 13B. The current waveforms for the “current sap” and “current pulse” are illustrated in FIGS. 13C and 13D respectively.

While the foregoing discussion presents the teachings in an exemplary fashion with respect to the disclosed method(s), system(s) and device(s) for generating sealing current from the customer premises or residence, it will be apparent to those skilled in the art that the present disclosure may apply to other method(s) and system(s) for generating and injecting sealing current into a Service Provider's telephone lines for DSL only or other dry or non-powered broadband service. Further, while the foregoing has described what are considered to be the best mode and/or other examples, it is understood that various modifications may be made therein and that the subject matter disclosed herein may be implemented in various forms and examples, and that the method(s), system(s) and device(s) may be applied in numerous applications, only some of which have been described herein.

What is claimed is:

1. A device for generating scaling current and for injecting sealing current into a service provider s telephone cables transporting DSL services, from a customer's premises or residence having a residential gateway or modem, the device comprising:
circuitry for generating the sealing current;
circuitry for injecting the scaling current into the telephone cables; and
test signature circuitry.

2. The device of claim 1, further comprising at least one connection for connecting the device between the telephone cables and the residential gateway or modem.

3. The device of claim 2, further comprising at least one connection for connecting the device between a power supply and the residential gateway or modem.

4. The device of claim 2, wherein the at least one connection for connecting the device between the telephone cables and the residential gateway or modem is an RJ11 or RJ14 connection.

5. The device of claim 2, wherein the at least one connection for connecting the device between the telephone cables and the residential gateway or modem is an RJ11 cable assembly.

6. The device of claim 3, wherein the at least one connection for connecting the device between a power supply and the residential gateway or modem is a DC power supply connector.

7. The device of claim 3, wherein the at least one connection for connecting the device between a power supply and the residential gateway or modem is a DC power cord.

8. The device of claim 1, further comprising an indicator for indicating when the device is powered.

9. The device of claim 1, further comprising an indicator for indicating when the device is generating current.

10. The device of claim 9, further comprising an additional indicator for indicating when the device is generating current.

11. A cable pair stabilizer device for use at a customer's premises or residence having a residential gateway or modem, and in connection with a service provider's telephone cables transporting DSL services, the device comprising:
a housing:
an AC/DC power supply adapter in the housing;
sealing current circuitry in the housing;
wherein the sealing current circuitry generates sealing current and injects the scaling current into the service provider's telephone cables transporting DSL services; and
test signature circuitry in the housing.

12. The device of claim 11, further comprising at least one connector for connecting the device between the telephone cables and the residential gateway or modem.

13. The device of claim 12, further comprising at least one connector for connecting the device between a power supply and the residential gateway or modem.

14. The device of claim 12, wherein the at least one connector for connecting the device between the telephone cables and the residential gateway or modem is an RJ11 jack or an RJ11 cable assembly.

15. The device of claim 13, wherein the at least one connector for connecting the device between a power supply and the residential gateway or modem is an AC power supply connector or a DC power cord.

16. The device of claim 11, further comprising an indicator for indicating when the device is powered.

17. The device of claim 11, further comprising at least one indicator for indicating when the device is generating current.

18. The device of claim 11, further comprising at least one indicator for indicating when the device is generating pulsed current.

19. A cable pair stabilizer device for use at a customer's premises or residence, and in connection with a service provider's telephone cables transporting DSL services, the device comprising:
a residential gateway or modem having a housing;
sealing current circuitry in the housing;
wherein the sealing current circuitry generates sealing current and injects the sealing current into the service provider's telephone cables transporting DSL services; and
test signature circuitry in the housing.

20. A method of generating sealing current for a service provider's telephone lines transporting DSL services, comprising the steps of:
providing a scaling current generating device at a customer's premises or residence:
providing test signature circuitry in the sealing current generating device;
injecting the scaling current into the telephone lines; and
proving a sealing current termination to close or complete a sealing current loop.
